(19) United States
(12) Patent Application Publication
(10) Pub. No.: US 2026/0213968 A1
(43) Pub. Date: Jul. 23, 2026

(54) SMF Pause of Charging

(71) Applicant: TELEFONAKTIEBOLAGET LM ERICSSON (PUBL), Stockholm (SE)

(72) Inventors: Jinyin Zhu, Shanghai (CN); Juying Gan, Shanghai (CN); Yingjiao He, Shanghai (CN); Zhansheng Wei, Shanghai (CN)

(21) Appl. No.: 19/142,863

(22) PCT Filed: Dec. 30, 2022
(86) PCT No.: PCT/CN2022/144023

§ 371 Date: Jun. 24, 2025

(51) Int. Cl. H04L 12/14; H04W 4/24

(52) U.S. Cl. CPC H04L 12/1407; H04W 4/24

(57) ABSTRACT

Methods and apparatus for improved SMF pause of charging are provided. A method (400) in a RAN node may include triggering (S404) a Session Management Function (SMF) pause of charging after a paging failure for a UE in RRC inactive status. A method (500) in the SMF may include being triggered (S504) for pause of charging by a RAN node after a paging failure for a UE in RRC inactive status, and enabling (S506) pause of charging.

### TECHNICAL FIELD

The present disclosure relates generally to the field of communication networks, and more specifically to techniques for improving Session Management Function (SMF) Pause of Charging functionality.

### BACKGROUND

At a high level, the 5G System (5GS) consists of an Access Network (AN) and a Core Network (CN). The AN provides UEs connectivity to the CN, e.g., via base stations such as gNBs or ng-eNBs. The CN includes a variety of Network Functions (NF) that provide a wide range of different functionalities such as session management, connection management, charging, authentication, etc.

FIG. 1A illustrates a 5G network architecture composed of core Network Functions (NFs), where interaction between any two NFs is represented by a point-to-point reference point/interface. Seen from the access side the 5G network architecture shown in FIG. 1A comprises a plurality of UEs 112 connected to either a RAN 102 or an Access Network (AN) as well as an Access and Mobility Management Function (AMF) 200. Typically, the RAN 102 comprises base stations, e.g. such as eNBs or gNBs. Seen from the core network side, the 5G core NFs shown in FIG. 1B include a Network Slice Selection Function (NSSF) 202, an Authentication Server Function (AUSF) 204, a Unified Data Management (UDM) 206, the AMF 200, a Session Management Function (SMF) 208, a Policy Control Function (PCF) 210, and an Application Function (AF) 212.

Reference point representations of the 5G network architecture are used to develop detailed call flows in the normative standardization. The N1 reference point is defined to carry signaling between the UE 112 and AMF 200. The reference points for connecting between the AN 102 and AMF 200 and between the AN 102 and UPF 214 are defined as N2 and N3, respectively. There is a reference point, N11, between the AMF 200 and SMF 208, which implies that the SMF 208 is at least partly controlled by the AMF 200. N4 is used by the SMF 208 and UPF 214 so that the UPF 214 can be set using the control signal generated by the SMF 208, and the UPF 214 can report its state to the SMF 208. N9 is the reference point for the connection between different UPFs 214, and N14 is the reference point connecting between different AMFs 200, respectively. N15 and N7 are defined since the PCF 210 applies policy to the AMF 200 and SMF 208, respectively. N12 is required for the AMF 200 to perform authentication of the UE 112. N8 and N10 are defined because the subscription data of the UE 112 is required for the AMF 200 and SMF 208.

The 5GC network aims at separating user plane and control plane. The user plane carries user traffic while the control plane carries signaling in the network. In FIG. 1B, the UPF 214 is in the user plane and all other NFs, i.e., the AMF 200, SMF 208, PCF 210, AF 212, NSSF 202, AUSF 204, and UDM 206, are in the control plane. Separating the user and control planes guarantees each plane resource to be scaled independently. It also allows UPFs to be deployed separately from control plane functions in a distributed fashion. In this architecture, UPFs may be deployed very close to UEs to shorten the Round Trip Time (RTT) between UEs and data network for some applications requiring low latency.

The core 5G network architecture is composed of modularized functions. For example, the AMF 200 and SMF 208 are independent functions in the control plane. Separated AMF 200 and SMF 208 allow independent evolution and scaling. Other control plane functions like the PCF 210 and AUSF 204 can be separated as shown in FIG. 1A. Modularized function design enables the 5GC network to support various services flexibly.

Each NF interacts with another NF directly. It is possible to use intermediate functions to route messages from one NF to another NF. In the control plane, a set of interactions between two NFs is defined as service so that its reuse is possible. This service enables support for modularity. The user plane supports interactions such as forwarding operations between different UPFs.

FIG. 1B illustrates a 5G network architecture using service-based interfaces between the NFs in the control plane, instead of the point-to-point reference points/interfaces used in the 5G network architecture of FIG. 1A. However, the NFs described above with reference to FIG. 1A correspond to the NFs shown in FIG. 1B. The service(s) etc. that a NF provides to other authorized NFs can be exposed to the authorized NFs through the service-based interface. In FIG. 1B the service based interfaces are indicated by the letter “N” followed by the name of the NF, e.g. Namf for the service based interface of the AMF 200 and Nsmf for the service based interface of the SMF 208, etc. The Network Exposure Function (NEF) 300 and the Network Repository Function (NRF) 302 in FIG. 1B are not shown in FIG. 1A discussed above. However, it should be clarified that all NFs depicted in FIG. 1A can interact with the NEF 300 and the NRF 302 of FIG. 1B as necessary, though not explicitly indicated in FIG. 1A.

Some properties of the NFs shown in FIGS. 1A and 1B may be described in the following. The AMF 200 provides UE-based authentication, authorization, mobility management, etc. A UE 112 even using multiple access technologies is basically connected to a single AMF 200 because the AMF 200 is independent of the access technologies. The SMF 208 is responsible for session management and allocates Internet Protocol (IP) addresses to UEs. It also selects and controls the UPF 214 for data transfer. If a UE 112 has multiple sessions, different SMFs 208 may be allocated to each session to manage them individually and possibly provide different functionalities per session. The AF 212 provides information on the packet flow to the PCF 210 responsible for policy control in order to support Quality of Service (QoS). Based on the information, the PCF 210 determines policies about mobility and session management to make the AMF 200 and SMF 208 operate properly. The AUSF 204 supports authentication function for UEs or similar and thus stores data for authentication of UEs or similar while the UDM 206 stores subscription data of the UE 112. The Data Network (DN), not part of the 5GC network, provides Internet access or operator services and similar.

An NF may be implemented either as a network element on a dedicated hardware, as a software instance running on a dedicated hardware, or as a virtualized function instantiated on an appropriate platform, e.g., a cloud infrastructure.

For more information, reference may be made to 3GPP TS 23.501 V17.6.0.

The SMF Pause of Charging functionality is supported with the purpose that the charging and usage monitoring data in the core network more accurately reflects the downlink traffic actually sent to the (R)AN. When the amount of downlink data incoming at the UPF for a PDU Session that is in deactivated state goes above a pre-configured threshold, the pause of charging functionality ensures that data that dropped in the core network is not included in charging and usage monitoring records.

The following are example triggers for the SMF to enable the pause of charging:
Operator specified criteria/threshold (e.g. number/fraction of packets/bytes dropped at UPF in downlink since last time the N3 tunnel towards the AN was released). The SMF requests the UPF to notify the SMF whenever the criteria/threshold is met;
Indication of “Radio Link Failure.”

For more information regarding pause of charging, please see 3GPP TS 23.501 V17.6.0 (clause 5.8.4) and 3GPP TS 23.502 V17.6.0 (clause 4.23.14).

For UE in RRC Inactive status, the UE may resume the RRC Connection due to
As a response to RAN paging.

If the RAN paging procedure, as defined in 3GPP TS 38.300 V17.2.0, is not successful in establishing contact with the UE the procedure shall be handled by the network as follows:
If NG-RAN has at least one pending NAS PDU for transmission, the RAN node shall initiate the AN Release procedure (see clause 4.2.6 of 3GPP TS 23.502 V17.6.0) to move the UE CM state in the AMF to CM-IDLE state and indicate to the AMF the NAS non-delivery;
If NG-RAN has only pending user plane data for transmission, the NG-RAN node may keep the N2 connection active or initiate the AN Release procedure (see clause 4.2.6 of 3GPP TS 23.502 V17.6.0) based on local configuration in NG-RAN.

For more information regarding RAN paging failure action, please see 3GPP TS 23.501 V17.6.0 (clause 5.3.3.2.5).

For UE in RRC Inactive status, if the RAN paging is not successful, the user plane data which triggers the RAN paging can be lost. However, dropped packets at the RAN have been charged in SMF, leading to inaccurate and over-charging for an end user.

### SUMMARY

Based on the above, problems currently exist with the SMF pause of charging procedure. Embodiments of the present disclosure address these and other problems, thereby facilitating more accurate charging and avoiding over-charging for an end user.

In some embodiments, a method in a Radio Access Network (RAN) node is provided including: triggering a Session Management Function (SMF) pause of charging after a paging failure for a user equipment (UE) in RRC inactive status.

In some embodiments, a method in a Session Management Function (SMF) is provided including: being triggered for pause of charging by a RAN node after a paging failure for a UE in RRC inactive status; and enabling pause of charging.

In some embodiments, a method in Access and Mobility Management Function (AMF) is provided including: receiving, from a RAN node, a number of downlink packets dropped at the RAN node after a paging failure for a UE in RRC inactive status; and sending the number of downlink packets dropped at the RAN node to SMF.

In some embodiments, a RAN node may include communication interface circuitry; and processing circuitry that is operably coupled to the communication interface circuitry. The processing circuitry and communication interface circuitry may be configured to perform operations corresponding to any of the above methods.

In some embodiments, a SMF/AMF of a communication network may be implemented by communication interface circuitry and processing circuitry that are operably coupled. The processing circuitry and communication interface circuitry may be configured to perform operations corresponding to any of the above methods.

In some embodiments, a SMF/AMF of a communication network may be configured to perform operations corresponding to any of the above methods.

In some embodiments, a non-transitory, computer-readable medium may be provided storing computer-executable instructions that, when executed by processing circuitry associated with a Radio Access Network (RAN) node or Session Management Function (SMF) or Access and Mobility Management Function (AMF) of a communication network, configure the RAN node or the SMF or the AMF to perform operations corresponding to any of the above methods.

### BRIEF DESCRIPTION OF THE DRAWINGS

These and other objects, features, and advantages of the present disclosure will become apparent upon reading the following Detailed Description in view of the Drawings briefly described below.

FIG. 1A illustrates a 5G network architecture composed of core Network Functions (NFs), where interaction between any two NFs is represented by a point-to-point reference point/interface.

FIG. 1B illustrates a 5G network architecture using service-based interfaces between the NFs in the control plane.

FIG. 2 shows a scenario in which downlink data dropped at NG-RAN is overcharged.

FIG. 3 shows another scenario in which downlink data dropped at NG-RAN is overcharged.

FIG. 4 is a flowchart illustrating an exemplary method in a RAN node according to various embodiments of the present disclosure.

FIG. 5 is a flowchart illustrating an exemplary method in SMF of a communication network (e.g., 5GC) according to various embodiments of the present disclosure.

FIG. 6 is a flowchart illustrating an exemplary method in AMF of a communication network (e.g., 5GC) according to various embodiments of the present disclosure.

FIGS. 7 to 9 each show a flowchart for an exemplary SMF pause of charging procedure according to various embodiments of the present disclosure.

FIG. 10 shows a communication system according to various embodiments of the present disclosure.

FIG. 11 shows a UE according to various embodiments of the present disclosure.

FIG. 12 shows a network node according to various embodiments of the present disclosure.

FIG. 13 shows host computing system according to various embodiments of the present disclosure.

FIG. 14 is a block diagram of a virtualization environment in which functions implemented by some embodiments of the present disclosure may be virtualized.

FIG. 15 illustrates communication between a host computing system, a network node, and a UE via multiple connections, according to various embodiments of the present disclosure.

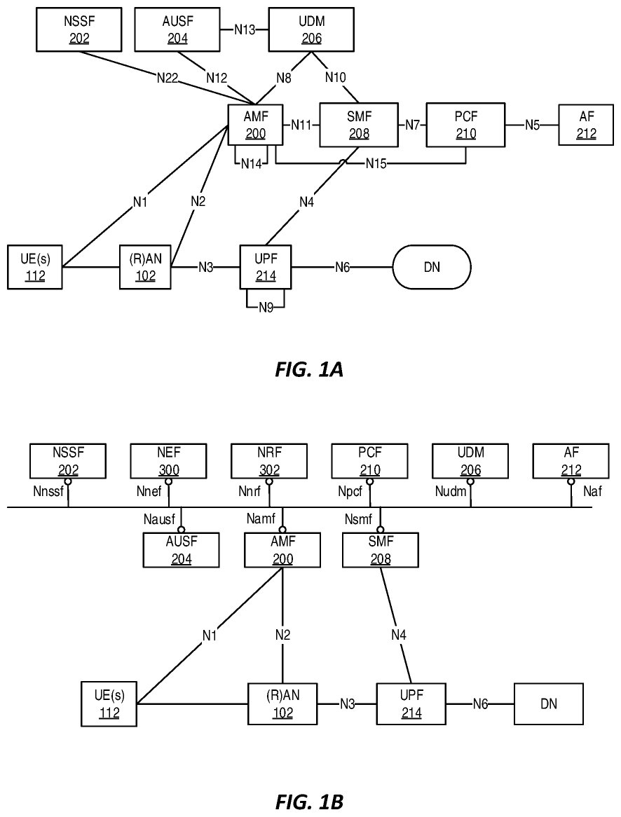

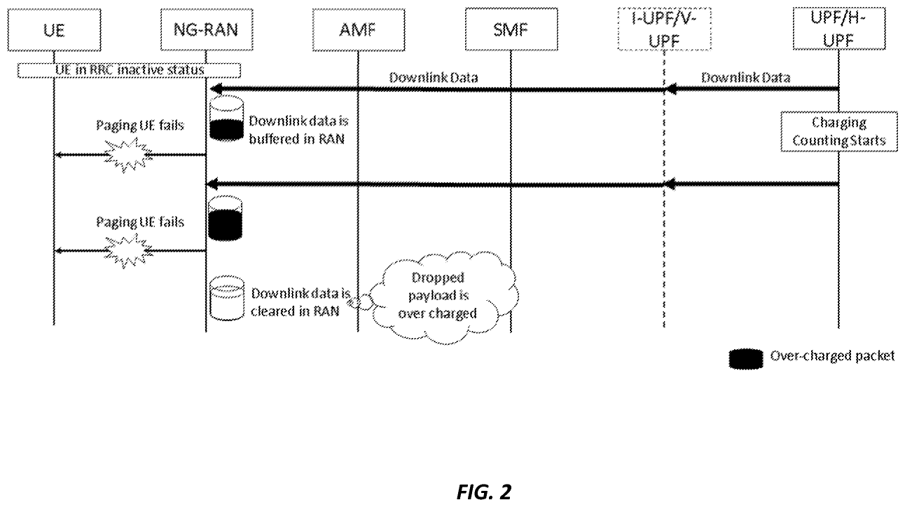

### DETAILED DESCRIPTION

Embodiments briefly summarized above will now be described more fully with reference to the accompanying drawings. These descriptions are provided by way of example to explain the subject matter to those skilled in the art and should not be construed as limiting the scope of the subject matter to only the embodiments described herein. More specifically, examples are provided below that illustrate the operation of various embodiments according to the advantages discussed above.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods and/or procedures disclosed herein do not have to be performed in the exact order disclosed, unless a step is explicitly described as following or preceding another step and/or where it is implicit that a step must follow or precede another step. Any feature of any of the embodiments disclosed herein can be applied to any other embodiment, wherever appropriate. Likewise, any advantage of any of the embodiments can apply to any other embodiments, and vice versa. Other objects, features and advantages of the disclosed embodiments will be apparent from the following description.

Furthermore, the following terms are used throughout the description given below:
Radio Access Node: As used herein, a “radio access node” or “radio network node” or “radio access network node” is any node in a radio access network of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), a relay node, a network node that implements part of the functionality of a base station (e.g., a network node that implements a gNB Central Unit or a network node that implements a gNB Distributed Unit) or a network node that implements part of the functionality of some other type of radio access node.
Core Network Node: As used herein, a “core network node” is any type of node in a core network. Some examples of a core network node include, e.g., a Mobility Management Entity (MME), a serving gateway (SGW), a Packet Data Network Gateway (P-GW), etc. A core network node can also be a node that implements a particular core network function (NF), such as an access and mobility management function (AMF), a session management function (SMF), a user plane function (UPF), a Service Capability Exposure Function (SCEF), or the like.
Network Node: As used herein, a “network node” is any node that is part of the core network (e.g., a core network node discussed above) of a telecommunications network. Functionally, a network node is equipment capable, configured, arranged, and/or operable to communicate directly or indirectly with a wireless or wired device and/or with other network nodes or equipment in the telecommunications network, to enable and/or provide wireless or wired access to the telecommunication device, and/or to perform other functions (e.g., administration) in the telecommunications network.
Node: As used herein, the term “node” (without any prefix) can be any type of node that is capable of operating in or with a telecommunication network (including a RAN and/or a core network), including a radio access node (or equivalent term), core network node, or telecommunications device.

Note that the description given herein focuses on a 3GPP telecommunications system and, as such, 3GPP terminology or terminology similar to 3GPP terminology is generally used. However, the concepts disclosed herein are not limited to a 3GPP system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from the concepts, principles, and/or embodiments described herein.

In addition, functions and/or operations described herein as being performed by a telecommunications device or a network node may be distributed over a plurality of telecommunications devices and/or network nodes.

For UE in RRC inactive status, if paging from a RAN node is not successful, downlink data (user plane data) which triggers the RAN paging can be lost. However, the dropped packets at the RAN node have been charged in SMF.

FIG. 2 shows a scenario in which downlink data dropped at a NG-RAN node is overcharged. After the page failure for UE in RRC inactive status, if the NG-RAN node keeps N2 connection active, downlink data received from UPF (V-UPF in case of HR (Home-Routed) roaming and I-UPF in case with SMF or I-SMF) of the core network may still been dropped. As shown in FIG. 2, the dropped packets (payload) at the NG-RAN node have been charged after the charging counting starts at the UPF, while the UE have not received any downlink data. There is no mechanism to trigger SMF for pause of charging. This leads to an over-charging for the UE.

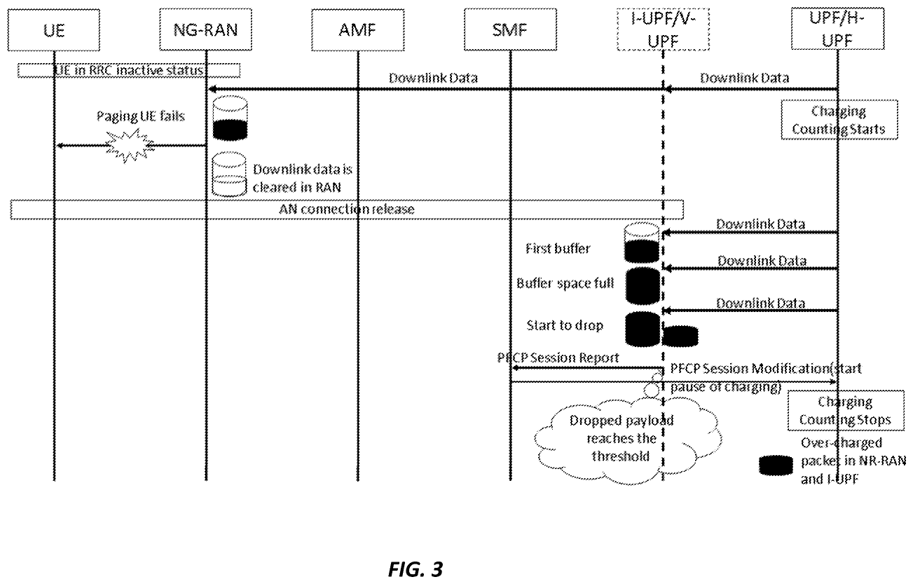

FIG. 3 shows another scenario in which downlink data dropped at a NG-RAN node is overcharged. After the page failure for UE in RRC inactive status, the NG-RAN node initiates AN release procedure. Before the AN release procedure is completed, some downlink data has been dropped at the NG-RAN node. Further, after the AN release procedure is completed, downlink data may be dropped in UPF (V-UPF in case of HR roaming and I-UPF in case with SMF or I-SMF). When the dropped packets reached a pre-configured threshold at the UPF, the UPF notifies the SMF that the threshold is met via PFCP session report, and the SMF starts pause of charging by notifying the UPF (H-UPF in case of HR roaming) of starting pause of charging via PFCP Session Modification Request message. The usage measurement in UPF is then stopped, that is, charging counting stops. But before that, some packets have been already dropped at the NG-RAN side. This makes the pause of charging based on the UPF-side threshold of dropped packets inaccurate, which results in over-charging for the UE.

Comparing with 2G/3G/4G user session, 5G indicates high bandwidth and many broadband applications including real time services. As a result, the packet loss volume will be big, and the end user will complain to the over-charging issue for the big loss packets. Further, when paging is failed for UE in RRC inactive status, keeping N2 connection active will increase the packet loss volume.

Techniques for improving Session Management Function (SMF) Pause of Charging functionality are needed for more accurate charging and avoiding over-charging for an end user.

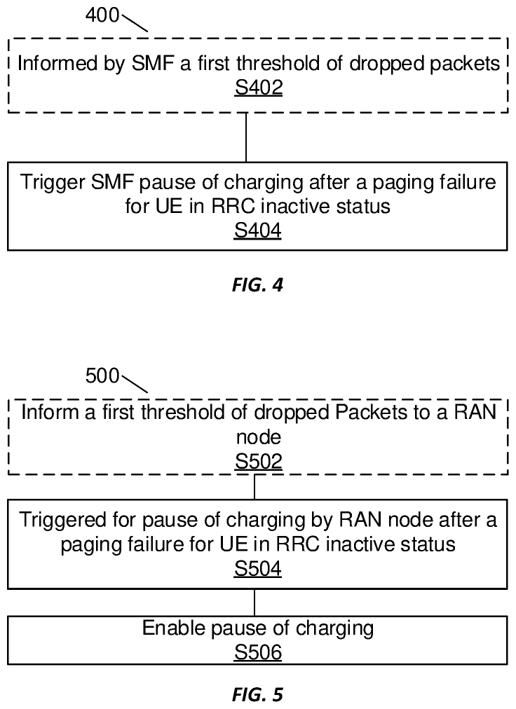

FIGS. 4 to 6 are flowcharts illustrating exemplary methods in a RAN node, a SMF and an AMF of a communication network (e.g., 5GC) respectively, according to various embodiments of the present disclosure.

With reference to FIG. 4, the method 400 in a RAN node (e.g., NG-RAN node) may include an operation of triggering a SMF pause of charging after a paging failure for a UE in RRC inactive status (S404).

In some embodiments, the method 400 may also optionally include, as shown in dashed-line blocks in FIG. 4, an operation of being informed, by the SMF, a first threshold of dropped packets (S402). The first threshold may be a threshold of dropped packet at the RAN node when the UE is in RRC Inactive status, and when the threshold is met, the RAN node indicates the SMF to start pause of charging. The RAN node may be informed of the first threshold by receiving a first message including the first threshold from the SMF. In an example, the RAN node may receive the first threshold in a Protocol Data Unit (PDU) Session Resource Setup Request message during a PDU Session Establishment procedure, or an Evolved Packet System (EPS) to 5G System (5GS) mobility procedure, or a N2 based Inter NG-RAN node handover. The first threshold may be included in PDU Session Resource Setup Request Transfer IE. In another example, the RAN node may receive may receive the first threshold in a Path Switch Request Acknowledge message during an Xn based Inter NG-RAN handover. The first threshold may be included in Path Switch Request Acknowledge Transfer IE.

The PDU Session Resource Setup Request Transfer IE (3GPP TS 38.413 V17.2.0, clause 9.3.4.1) may be modified as follows to include the first threshold (e.g., named “RRC Inactive Dropped Packet Threshold”):

TABLE 1

| | | | IE type and | Semantics | | Assigned |
|---|---|---|---|---|---|---|
| IE/Group Name | Presence | Range | reference | description | Criticality | Criticality |
| PDU Session | O | | 9.3.1.102 | This IE shall be | YES | reject |
| Aggregate | | | | present when at | | |
| Maximum | | | | least one Non- | | |
| Bit Rate | | | | GBR QoS flow | | |
| | | | | is being setup | | |
| | | | | and is ignored | | |
| | | | | otherwise. | | |
| QoS Flow Setup | | 1 | | | YES | reject |
| Request List | | | | | | |
| QoS Flow Setup | | 1 . . . <maxno | | | — | |
| Request Item | | ofQoSFlo | | | | |
| | | ws> | | | | |
| QoS Flow Identifier | M | | 9.3.1.51 | | — | |
| QoS Flow Level | M | | 9.3.1.12 | | — | |
| QoS Parameters | | | | | | |
| E-RAB ID | O | | 9.3.2.3 | | — | |
| TSC Traffic | O | | 9.3.1.130 | This IE may be | YES | ignore |
| Characteristics | | | | present in case | | |
| | | | | of GBR QoS flows | | |
| | | | | and is ignored | | |
| | | | | otherwise. | | |
| Redundant QoS | O | | 9.3.1.134 | This IE indicates | YES | ignore |
| Flow Indicator | | | | whether this QoS | | |
| | | | | flow is requested | | |
| | | | | for the redundant | | |
| | | | | transmission. | | |
| RRC Inactive | O | | | This IE indicates | YES | ignore |
| Dropped Packet | | | | the threshold of | | |
| Threshold | | | | dropped packet | | |
| | | | | when a UE is in | | |
| | | | | RRC Inactive status | | |
| | | | | at which NG-RAN | | |
| | | | | indicates SMF to | | |
| | | | | start pause of | | |
| | | | | charging. | | |

The Path Switch Request Acknowledge Transfer IE (3GPP TS 38.413 V17.2.0, clause 9.3.4.9) may be modified as follows to include the first threshold (e.g., named “RRC Inactive Dropped Packet Threshold”):

TABLE 2

| | | | IE type and | Semantics | | Assigned |
|---|---|---|---|---|---|---|
| IE/Group Name | Presence | Range | reference | description | Criticality | Criticality |
| UL NG-U UP | O | | UP | UPF endpoint of | — | |
| TNL Information | | | Transport | the NG-U | | |
| | | | Layer | transport bearer | | |
| | | | Information | corresponding to | | |
| | | | 9.3.2.2 | the DL NG-U UP | | |
| | | | | TNL Information | | |
| | | | | IE received in the | | |
| | | | | Path Switch | | |
| | | | | Request Transfer | | |
| | | | | IE. | | |
| Security Indication | O | | 9.3.1.27 | | — | |
| QoS Flow | | 0 . . . 1 | | | YES | ignore |
| Parameters List | | | | | | |
| QoS Flow | | 1 . . . <maxno | | | — | |
| Parameters Item | | ofQoSFlo | | | | |
| | | WS> | | | | |
| Burst Arrival Time | O | | Burst Arrival | Indicates the | YES | ignore |
| Downlink | | | Time | downlink Burst | | |
| | | | 9.3.1.133 | Arrival Time of | | |
| | | | | the TSC QoS flow | | |
| RRC Inactive | O | | | This IE indicates | YES | ignore |
| Dropped Packet | | | | the threshold of | | |
| Threshold | | | | dropped packet | | |
| | | | | when a UE is in | | |
| | | | | RRC Inactive status | | |
| | | | | at which NG-RAN | | |
| | | | | indicates SMF to | | |
| | | | | start pause of | | |
| | | | | charging. | | |

In some embodiments, if N2 connection is kept after the paging failure, the RAN node may trigger the SMF pause of charging by, when the number of downlink packets dropped at the RAN node after the page failure reaches the first threshold, informing the SMF of a first indicator indicating that the number of downlink packets dropped at the RAN node reaches the first threshold. The first indicator may indicate to the SMF that the first threshold (e.g., named “RRC Inactive Dropped Packet Threshold”) is reached so as to trigger the SMF to start pause of charging.

In some embodiments, the RAN node may include or enable the first indicator in a second message, and sending the second message to the SMF. For example, the RAN node may set the first indicator to “1” to indicate that the first threshold is reached. In an example, the second message may be a PDU Session Resource Notify message, and the first indicator may be included in a PDU Session Resource Notify Transfer IE.

In some embodiments, after the RAN node sends the first indicator to the SMF, when the paging for the UE is successful, the RAN node may inform the SMF to stop the pause of charging. In an example, the RAN node may include or enable a second indicator in a third message, and sending the third message to the SMF. The second indicator may indicate that RRC connection for the UE is resumed, so that the SMF may stop pause of charging. For example, the RAN node may set the second indicator to “1” to indicate that RRC connection for the UE is resumed after the paging failure for the UE in RRC inactive status. In an example, the third message may be a PDU Session Resource Notify message, and the second indicator may be included in a PDU Session Resource Notify Transfer IE.

The PDU Session Resource Notify Transfer IE (3GPP TS 38.413 V17.2.0, clause 9.3.4.5) may be modified as follows to include the first indicator (e.g., named “RRC Inactive Dropped Packet Threshold Reached Indicator”) and the second indicator (e.g., named “RRC Connection Resumed Indicator”):

TABLE 3

| | | | IE type and | Semantics | | Assigned |
|---|---|---|---|---|---|---|
| IE/Group Name | Presence | Range | reference | description | Criticality | Criticality |
| QoS Flow Notify List | | 0 . . . 1 | | | — | |
| QoS Flow Notify Item | | 1 . . . <maxno | | | — | |
| | | ofQoSFlo | | | | |
| | | WS> | | | | |
| QoS Flow Identifier | M | | 9.3.1.51 | | — | |
| Notification Cause | M | | ENUMERATED | | — | |
| | | | (fullfilled, not | | | |
| | | | fulfilled, . . .) | | | |
| Current QoS | O | | Alternative QoS | Index to the | YES | Ignore |
| Parameters Set | | | Parameters Set | currently fulfilled | | |
| Index | | | Notify Index | alternative QoS | | |
| | | | 9.3.1.153 | parameters set. | | |
| | | | | Value 0 indicates | | |
| | | | | that NG-RAN | | |
| | | | | cannot even fulfil | | |
| | | | | the lowest | | |
| | | | | alternative | | |
| | | | | parameters set. | | |
| QoS Flow Released | O | | QoS Flow List | | — | |
| List | | | with Cause | | | |
| | | | 9.3.1.13 | | | |
| RRC Inactive | | | | When the RRC | YES | ignore |
| Dropped Packet | | | | Inactive Dropped | | |
| Threshold Reached | | | | packets at NG-RAN | | |
| Indicator | | | | reached the RRC | | |
| | | | | Inactive Dropped | | |
| | | | | Packet Threshold, | | |
| | | | | NG-RAN send this | | |
| | | | | indicator to SMF or | | |
| | | | | set the indicator to 1. | | |
| RRC Connection | | | | When the paging is | YES | ignore |
| Resumed Indicator | | | | successful for a UE | | |
| | | | | in RRC Inactive | | |
| | | | | status, before | | |
| | | | | sending of payload to | | |
| | | | | UE, if NG-RAN has | | |
| | | | | sent the RRC Inactive | | |
| | | | | Dropped Packet | | |
| | | | | Threshold Reached | | |
| | | | | Indicator before, it | | |
| | | | | sends the RRC | | |
| | | | | Connection Resumed | | |
| | | | | Indicator to SMF or | | |
| | | | | set the indicator to 1. | | |

Provided with the first threshold of dropped packet, the RAN node can trigger the SMF pause of charging upon the first threshold being reached, even in the case of keeping N2 connection after a paging failure for a UE in RRC inactive status. In this way, the RAN node is provided with a mechanism to trigger SMF for pause of charging, and over-charging for the UE as shown in FIG. 2 can be avoided.

In some embodiments, the RAN node may trigger the SMF pause of charging by initiating AN release procedure when the number of downlink packets dropped at the RAN node after the page failure reaches the first threshold, and informing the number of downlink packets dropped at the RAN node before the AN release procedure to AMF, via which the number of downlink packets is to be forwarded to the SMF.

In some embodiments, if the RAN node initiates AN release procedure after the paging failure (for example, if the RAN node initiates AN release procedure before the number of downlink packets dropped at the RAN node after the page failure reaches the first threshold; or whenever the RAN node initiates AN release procedure after the paging failure for the UE in RRC Inactive status), the RAN node may trigger the SMF pause of charging by informing the number of downlink packets dropped at the RAN node before the AN release procedure to the AMF, via which the number of downlink packets is to be forwarded to the SMF.

Upon being informed of the number of downlink packets at the RAN node, the SMF may start pause of charging immediately, or may setting, to the UPF (V-UPF in case of HR roaming and I-UPF in case with SMF or I-SMF), a second threshold of dropped packets by taking into account the number of downlink packets dropped at the RAN node, in place of the pre-configured threshold at the UPF. In an example, the second threshold of dropped packets may be set as the pre-configured threshold of dropped packets at the UPF minus the number of downlink packets dropped at the RAN node.

In an example, the RAN node may include the number of downlink packets dropped at the RAN node in a UE Context Release Request message sent to the AMF. The UE Context Release Request message (3GPP TS 38.413 V17.2.0, clause 9.2.2.4) may be modified as follows to include the number of downlink packets dropped at the RAN node before the AN release procedure (e.g., named “RRC Inactive Dropped Packets”):

TABLE 4

| | | | IE type and | Semantics | | Assigned |
|---|---|---|---|---|---|---|
| IE/Group Name | Presence | Range | reference | description | Criticality | Criticality |
| Message Type | M | | 9.3.1.1 | | YES | ignore |
| AMF UE NGAP ID | M | | 9.3.3.1 | | YES | reject |
| RAN UE NGAP ID | M | | 9.3.3.2 | | YES | reject |
| PDU Session | | 0 . . . 1 | | | YES | reject |
| Resource List | | | | | | |
| PDU Session | | 1 . . . <maxno | | | — | |
| Resource Item | | ofPDUSes | | | | |
| | | sions> | | | | |
| PDU Session ID | M | | 9.3.1.50 | | — | |
| RRC Inactive | O | | | The number of | YES | ignore |
| Dropped Packets | | | | dropped packets | | |
| | | | | of the PDU session | | |
| | | | | for UE in RRC | | |
| | | | | inactive status before | | |
| | | | | the AN release | | |
| | | | | procedure. | | |
| Cause | M | | 9.3.1.2 | | YES | ignore |

By informing the number of dropped packets at the RAN node to the SMF, the RAN node can trigger an immediate SMF pause of charging, or trigger the SMF to set, to the UPF, an updated threshold of dropped packets by taking into account the number of downlink packets dropped at the RAN node. In this way, it is possible to consider the dropped packets at the RAN node in charging counting, enabling a more accurate charging and avoiding over-charging for the UE as shown in FIG. 3.

With reference to FIG. 5, the method 500 in a SMF of a communication network (e.g., 5GC) may include operations of being triggered for pause of charging by a RAN node after a paging failure for a UE in RRC inactive status (S504), and enabling the pause of charging (S506).

In some embodiments, the method 500 may also optionally include, as shown in dashed-line blocks in FIG. 5, an operation of informing the RAN node of the first threshold of dropped packets (S502). The SMF may include the first threshold of dropped packets in the first message sent to the RAN node. The first threshold of dropped packets and the first message have been described above with reference to Table 1 and Table 2.

In some embodiments, the SMF may be triggered for pause of charging by receiving, from the RAN node that keeps N2 connection after the paging failure, the first indicator indicating that the number of downlink packets dropped at the RAN node after the paging failure reaches the first threshold. The SMF may enable the pause of charging by, in response to receiving the first indicator, sending a request for stopping charging counting to the UPF.

In some embodiments, after enabling pause of charging, the SMF may be informed by the RAN node to stop the pause of charging, for example, by receiving the second indicator indicating that RRC connection for the UE is resumed from the RAN node. Then, the SMF may stop the pause of charging by sending a request for starting charging counting to the UPF.

The first and second indicators have been described above with reference to Table 3.

In some embodiments, the SMF is triggered for pause of charging by being informed of the number of downlink packets dropped at the RAN node. In an example, the SMF may receive from the AMF a first request message including the number of downlink packets dropped at the RAN node. The AMF may be informed, by the RAN node that initiates AN release procedure, of the number of downlink packets dropped at the RAN node after the paging failure for the UE in RRC inactive status, and then forward the number of the dropped downlink packets to the SMF.

In an example, the first request message may be Nsmf_PDUSession_UpdateSMContext Request. In this case, “Table 6.1.6.2.4-1: Definition of type SmContextUpdateData” (3GPP TS 29.502 V17.6.0, clause 6.1.6.2.4) may be modified as follows to include the number of downlink packets dropped at the RAN node (e.g., named “RRC Inactive Dropped Packets”):

TABLE 5

| | | | | | |
|---|---|---|---|---|---|
| Attribute name | Data type | P | Cardinality | Description | Applicability |

| | | | | |
|---|---|---|---|---|
| pei | Pei | C | 0 . . . 1 | This IE shall be present if it is available and has not |
| | | | | been provided earlier to the SMF. |
| | | | | When present, this IE shall contain the permanent |
| | | | | equipment identifier. |
| . . . | . . . | . . . | . . . | . . . |
| ueTimeZone | TimeZone | C | 0 . . . 1 | This IE shall be present if it is available, the UE Time |
| | | | | Zone has changed and needs to be reported to the |
| | | | | SMF. |
| | | | | When present, this IE shall contain the UE Time |
| | | | | Zone. |
| . . . | . . . | . . . | . . . | . . . |
| upCnxState | UpCnxState | C | 0 . . . 1 | This IE shall be present to request the activation or |
| | | | | the deactivation of the user plane connection of the |
| | | | | PDU session. |
| | | | | When present, it shall be set as specified in clauses |
| | | | | 5.2.2.3.2, 5.2.2.3.15 and 5.2.2.3.16. |
| . . . | . . . | . . . | . . . | . . . |
| RRC Inactive | | | | The number of dropped packets of the PDU |
| Dropped Packets | | | | session for UE in RRC inactive status before the |
| | | | | AN release procedure. |
| ngApCause | NgApCause | C | 0 . . . 1 | This IE shall be present, if the information is |
| | | | | available. When present, this IE shall indicate the |
| | | | | cause for the requested modification, e.g. the NGAP |
| | | | | cause for requesting to deactivate the user plane |
| | | | | connection of the PDU session. |

In some embodiments, the SMF may start the pause of charging immediately by, in response to being informed of the number of downlink packets, sending a request for stopping charging counting to the UPF.

In some embodiments, the SMF may set to the UPF (V-UPF in case of HR roaming and I-UPF in case with SMF or I-SMF), in response to being informed of the number of downlink packets dropped at the RAN node, the second threshold of dropped packets by taking into account the number of downlink packets dropped at the RAN node. In an example, the SMF may set the second threshold to the UPF (V-UPF in case of HR roaming and I-UPF in case with SMF or I-SMF) by sending to the UPF a request for updating the pre-configured threshold of dropped packets at the UPF with the second threshold.

In this case, when the number of downlink packets dropped at the UPF (V-UPF in case of HR roaming and I-UPF in case with SMF or I-SMF) reaches the second threshold instead of the pre-configured threshold at the UPF, the UPF may notify the SMF that the second threshold is reached. Then, the SMF may send a request for stopping charging counting to the UPF (H-UPF in case of HR roaming).

In an example, the request for stopping charging counting and the request for updating the pre-configured threshold each may be a Packet Forwarding Control Protocol (PFCP) Session Modification Request.

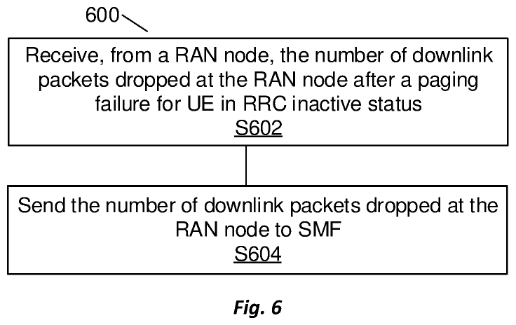

FIG. 6 shows a flowchart of an exemplary method in an AMF of a communication network (e.g., 5GC) according to various embodiments of the present disclosure. The method 600 in the AMF may include operations of receiving, from a RAN node, the number of downlink packets dropped at the RAN node after a paging failure for a UE in RRC inactive status (S602), and sending the number of downlink packets dropped at the RAN node to a SMF (S604). As described above with reference to FIGS. 4 and 5, the AMF may receive the number of downlink packets dropped at the RAN node included in a UE Context Release Request message transmitted from the RAN node during AN release procedure, and then the AMF may send the number of downlink packets dropped at the RAN node to a SMF by including it in the first request message, for example, Nsmf_PDUSession_UpdateSMContext Request message.

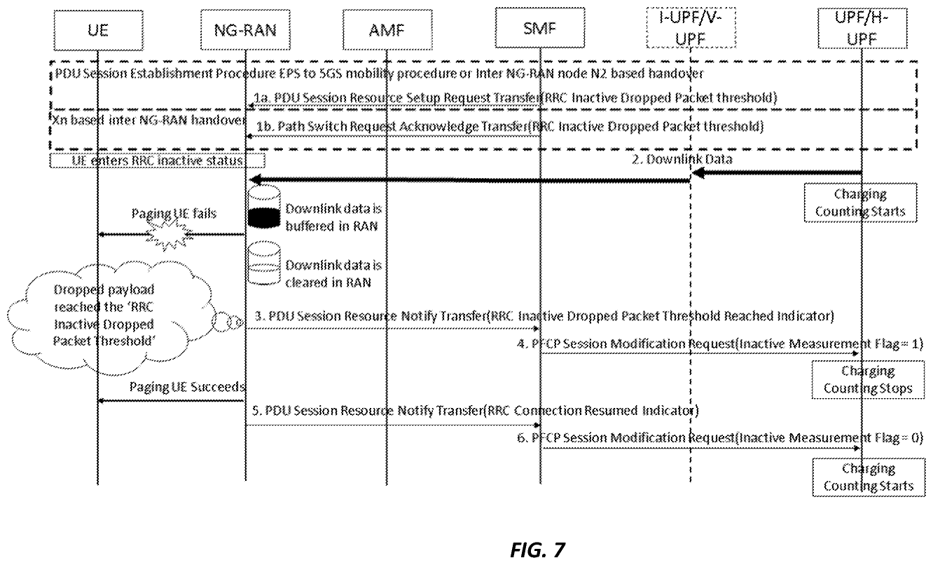

So far, the methods in the RAN node, SMF and AMF for improved pause of charging have been described. In the following, examples of the methods will be described in connection with FIGS. 7 to 9.

FIG. 7 is a flowchart for an exemplary SMF pause of charging procedure in case of keeping N2 connection after a paging failure for UE in RRC inactive status, according to various embodiments of the present disclosure. The flow may include the following steps.

The SMF indicates the RRC Inactive Dropped Packet threshold to the NG-RAN, specifically:
step 1a of indicating the RRC Inactive Dropped Packet threshold included in the PDU Session Resource Setup Request Transfer IE to the NG-RAN during a PDU Session Establishment procedure or an EPS to 5GS mobility procedure or a N2 based inter NG-RAN node handover procedure, or
step 1b of indicating the RRC Inactive Dropped Packet threshold included in the Path Switch Request Acknowledge Transfer IE to the NR-RAN during an Xn based inter NG-RAN handover procedure.

At step 2, there is downlink data received from core network (e.g., the user plane data) When the UE is in RRC inactive status, which triggers the NG-RAN to page the UE; if the paging fails, the downlink data may be dropped by the NG-RAN.

At step 3, when the number of downlink packets dropped at the NG-RAN reaches the RRC Inactive Dropped Packet threshold, if the N2 connection is kept, the NG-RAN indicates, to the SMF, the RRC Inactive Dropped Packet Threshold Reached Indicator in the PDU Session Resource Notify Transfer IE.

At step 4, the SMF then starts pause of charging by setting the Inactive Measurement Flag=1 to UPF (H-UPF in case of HR roaming) in PFCP Session Modification Request message; and the usage measurement (and the charging counting) in the UPF is stopped;

At step 5, when the paging is successful, the NG-RAN indicates to the SMF the RRC Connection Resumed Indicator in the PDU Session Resource Notify Transfer IE.

At step 6, the SMF stops pause of charging by setting the Inactive Measurement Flag=0 to UPF (H-UPF in case of HR roaming) in PFCP Session Modification Request message; and the usage measurement (and the charging counting) in the UPF continues.

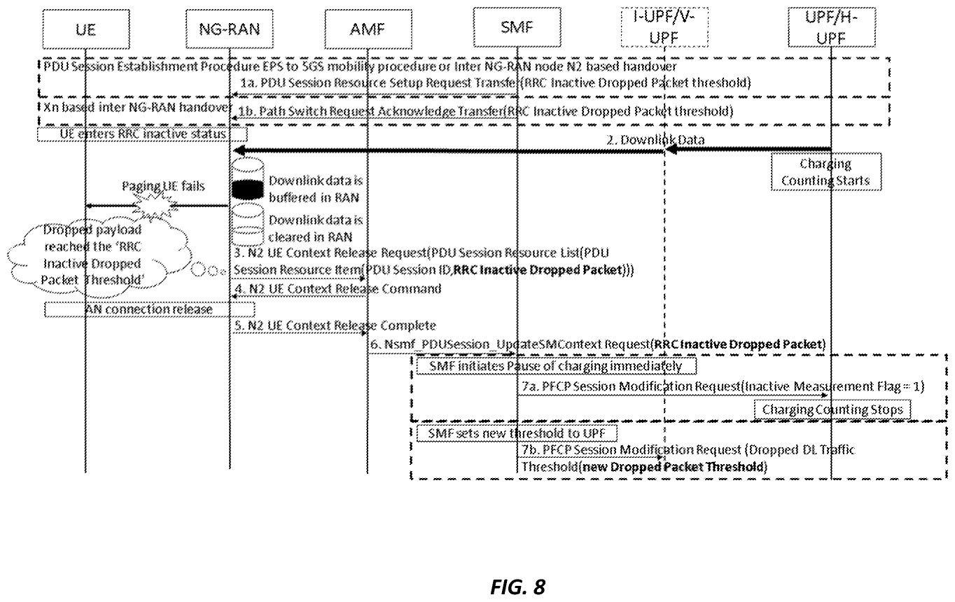

FIG. 8 is a flowchart for an exemplary SMF pause of charging procedure in case of initiating AN release procedure after a paging failure for UE in RRC inactive status, according to various embodiments of the present disclosure. In FIG. 8, the AN release procedure is initiated by the NG-RAN in response to the RRC Inactive Dropped Packet threshold being reached. Steps 1a, 1b and 2 are the same as those in FIG. 7, and thus repeated description is omitted here.

At step 3, when the RRC Inactive Dropped Packet threshold is reached, the NG-RAN initiates AN release procedure and sends to the AMF a N2 UE Context Release request message in which the number of downlink packets dropped at the NG-RAN (“RRC Inactive Dropped Packet”) is included.

At step 4, the AMF sends N2 UE Context Release Command to the NG-RAN, and the AN connection is released.

At step 5, the AMF receives N2 UE Context Release Complete from the NG-RAN.

At step 6, the AMF includes umber of downlink packets dropped at the NG-RAN in Nsmf_PDUSession_UpdateSMContext Request and sends it to the SMF.

When the SMF receives the number of downlink packets dropped at the NG-RAN from the AMF, the SMF may perform, for example, depending on a local policy, one of:
step 7a of starting pause of charging immediately by setting the Inactive Measurement Flag=1 to the UPF (H-UPF in case of HR roaming) in PFCP Session Modification Request message; or
step 7b of setting, to the UPF (V-UPF in case of HR roaming and I-UPF in case with SMF or I-SMF), a new threshold (“new Dropped Packet Threshold”) in PFCP Session Modification Request message by taking into account the number of downlink packets dropped at the NG-RAN, for example, the new threshold is equal to the pre-configured threshold (“Dropped DL Traffic Threshold”) at the UPF minus the number of downlink packets dropped at the NG-RAN.

In case of step 7b, when the dropped packets at the UPF (V-UPF in case of HR roaming and I-UPF in case with SMF or I-SMF) reached the new threshold at the UPF, the UPF notifies the SMF that the threshold is met via PFCP session report, and the SMF starts pause of charging by notifying the UPF (H-UPF in case of HR roaming) of starting pause of charging via PFCP Session Modification Request message. The usage measurement in the UPF is then stopped, that is, charging counting stops.

The pause of charging may be stopped in the next network trigger service request procedure as conventionally implemented.

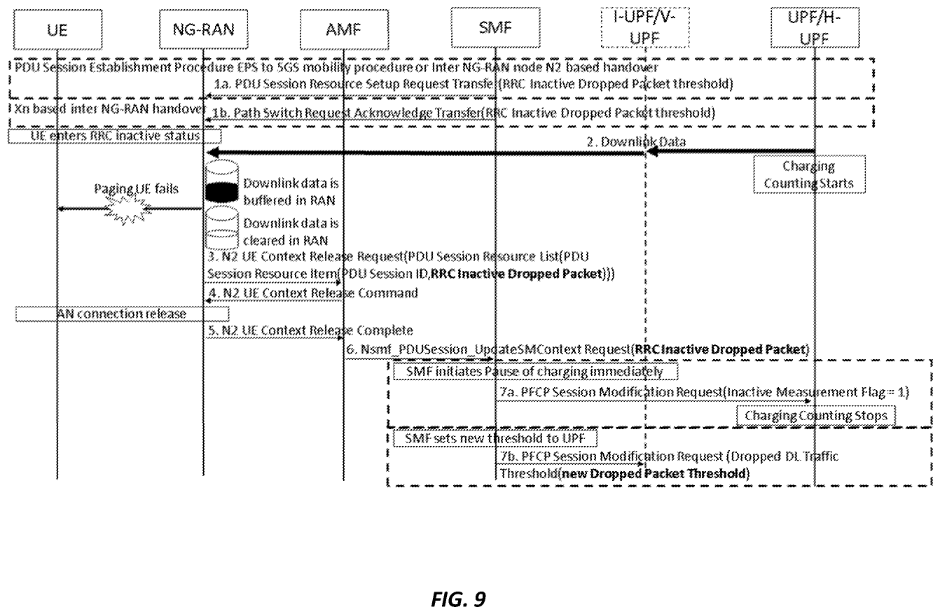

FIG. 9 is another flowchart for an exemplary SMF pause of charging procedure in case of initiating AN release procedure after a paging failure for UE in RRC inactive status, according to various embodiments of the present disclosure. Different from FIG. 8 where the AN release procedure is initiated in response to the RRC Inactive Dropped Packet threshold being reached, in FIG. 9 the AN release procedure is initiated by the NG-RAN, for example, before the number of downlink packets dropped at the NG-RAN reaches the RRC Inactive Dropped Packet threshold. Except step 3, the other steps in FIG. 9 are the same as those in FIG. 8, and thus repeated description is omitted here.

At step 3, the NG-RAN initiates AN release procedure (for example, before the RRC Inactive Dropped Packet threshold is reached), and sends to the AMF a N2 UE Context Release request message in which the number of downlink packets dropped at the NG-RAN (“RRC Inactive Dropped Packet”) is included.

Examples of the SMF pause of charging procedure have been described in which the RAN node is provided with a mechanism to trigger the SMF pause of charging in case of paging failure for the UE in RRC inactive status, by indicating to the SMF that “RRC Inactive Dropped Packet threshold” is reached or notifying the number of dropped packets at the RAN node to the SMF. In this way, the concept of pause of charging is extended from the UPF to the RAN node for UE in RRC inactive status. Even in case of keeping N2 connection active after the paging failure, it is possible for the RAN node to trigger SMF for pause of charging. Further, the RAN node can notify the number of dropped packets at the RAN node to the SMF, and this information can be considered in charging counting. Therefore, it is possible to make the charging more accuracy and avoid over-charging for an end user.

Although various embodiments are described herein above in terms of methods, apparatus, devices, computer-readable medium and receivers, the person of ordinary skill will readily comprehend that such methods can be embodied by various combinations of hardware and software in various systems, communication devices, computing devices, control devices, apparatuses, non-transitory computer-readable media, etc.

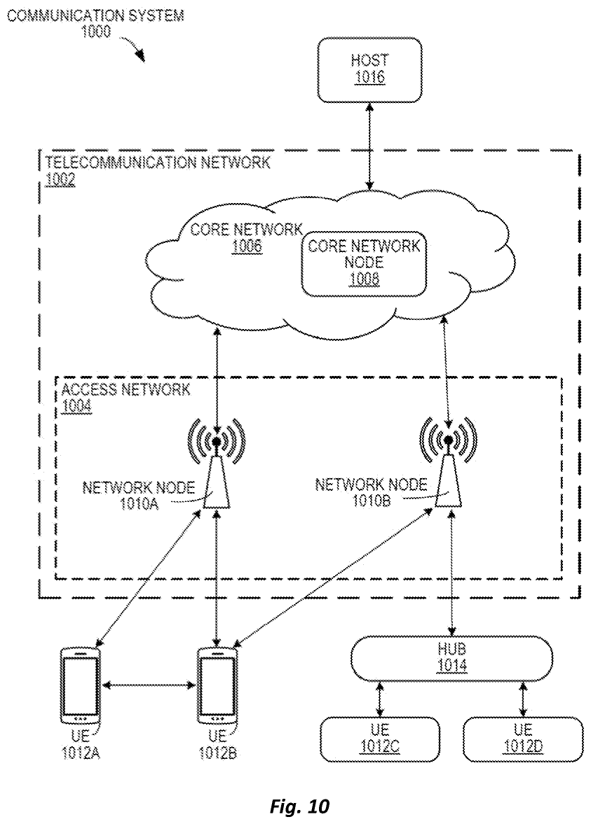

FIG. 10 shows an example of a communication system 1000 in accordance with some embodiments. The concept of the present disclosure may be applied in the communication system 1000. In this example, the communication system 1000 includes a telecommunication network 1002 that includes an access network 1004, such as a radio access network (RAN), and a core network 1006, which includes one or more core network nodes 1008. The access network 1004 includes one or more access network nodes, such as network nodes 1010a and 1010b (one or more of which may be generally referred to as network nodes 1010), or any other similar 3rd Generation Partnership Project (3GPP) access node or non-3GPP access point. The network nodes 1010 facilitate direct or indirect connection of user equipment (UE), such as by connecting UEs 1012a, 1012b, 1012c, and 1012d (one or more of which may be generally referred to as UEs 1012) to the core network 1006 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1000 may include any number of wired or wireless networks, network nodes, UEs, and/or any other components or systems that may facilitate or participate in the communication of data and/or signals whether via wired or wireless connections. The communication system 1000 may include and/or interface with any type of communication, telecommunication, data, cellular, radio network, and/or other similar type of system.

The UEs 1012 may be any of a wide variety of communication devices, including wireless devices arranged, configured, and/or operable to communicate wirelessly with the network nodes 1010 and other communication devices. Similarly, the network nodes 1010 are arranged, capable, configured, and/or operable to communicate directly or indirectly with the UEs 1012 and/or with other network nodes or equipment in the telecommunication network 1002 to enable and/or provide network access, such as wireless network access, and/or to perform other functions, such as administration in the telecommunication network 1002.

In the depicted example, the core network 1006 connects the network nodes 1010 to one or more hosts, such as host 1016. These connections may be direct or indirect via one or more intermediary networks or devices. In other examples, network nodes may be directly coupled to hosts. The core network 1006 includes one more core network nodes (e.g., core network node 1008) that are structured with hardware and software components. Features of these components may be substantially similar to those described with respect to the UEs, network nodes, and/or hosts, such that the descriptions thereof are generally applicable to the corresponding components of the core network node 1008. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF). The SMF and AMF as well as methods in them according to various embodiments of the present disclosure may be implemented in the core network nodes.

The host 1016 may be under the ownership or control of a service provider other than an operator or provider of the access network 1004 and/or the telecommunication network 1002, and may be operated by the service provider or on behalf of the service provider. The host 1016 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

In various embodiments, core network node 1008 can implement network function (NF) of communication system or network 900. In other words, the NF may be located in the core network 1006 or coupled to the core network 1006. Such a NF can be configured to perform operations corresponding to exemplary methods described above.

As a whole, the communication system 1000 of FIG. 10 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1002 is a cellular network that implements 3GPP standardized features. Accordingly, the telecommunications network 1002 may support network slicing to provide different logical networks to different devices that are connected to the telecommunication network 1002. For example, the telecommunications network 1002 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1012 are configured to transmit and/or receive information without direct human interaction. For instance, a UE may be designed to transmit information to the access network 1004 on a predetermined schedule, when triggered by an internal or external event, or in response to requests from the access network 1004. Additionally, a UE may be configured for operating in single- or multi-RAT or multi-standard mode. For example, a UE may operate with any one or combination of Wi-Fi, NR (New Radio) and LTE, i.e., being configured for multi-radio dual connectivity (MR-DC), such as E-UTRAN (Evolved-UMTS Terrestrial Radio Access Network) New Radio-Dual Connectivity (EN-DC).

In the example, the hub 1014 communicates with the access network 1004 to facilitate indirect communication between one or more UEs (e.g., UE 1012c and/or 1012d) and network nodes (e.g., network node 1010b). In some examples, the hub 1014 may be a controller, router, content source and analytics, or any of the other communication devices described herein regarding UEs. For example, the hub 1014 may be a broadband router enabling access to the core network 1006 for the UEs. As another example, the hub 1014 may be a controller that sends commands or instructions to one or more actuators in the UEs. Commands or instructions may be received from the UEs, network nodes 1010, or by executable code, script, process, or other instructions in the hub 1014. As another example, the hub 1014 may be a data collector that acts as temporary storage for UE data and, in some embodiments, may perform analysis or other processing of the data. As another example, the hub 1014 may be a content source. For example, for a UE that is a VR headset, display, loudspeaker or other media delivery device, the hub 1014 may retrieve VR assets, video, audio, or other media or data related to sensory information via a network node, which the hub 1014 then provides to the UE either directly, after performing local processing, and/or after adding additional local content. In still another example, the hub 1014 acts as a proxy server or orchestrator for the UEs, in particular in if one or more of the UEs are low energy IoT devices.

The hub 1014 may have a constant/persistent or intermittent connection to the network node 1010b. The hub 1014 may also allow for a different communication scheme and/or schedule between the hub 1014 and UEs (e.g., UE 1012c and/or 1012d), and between the hub 1014 and the core network 1006. In other examples, the hub 1014 is connected to the core network 1006 and/or one or more UEs via a wired connection. Moreover, the hub 1014 may be configured to connect to an M2M service provider over the access network 1004 and/or to another UE over a direct connection. In some scenarios, UEs may establish a wireless connection with the network nodes 1010 while still connected via the hub 1014 via a wired or wireless connection. In some embodiments, the hub 1014 may be a dedicated hub—that is, a hub whose primary function is to route communications to/from the UEs from/to the network node 1010b. In other embodiments, the hub 1014 may be a non-dedicated hub—that is, a device which is capable of operating to route communications between the UEs and network node 1010b, but which is additionally capable of operating as a communication start and/or end point for certain data channels.

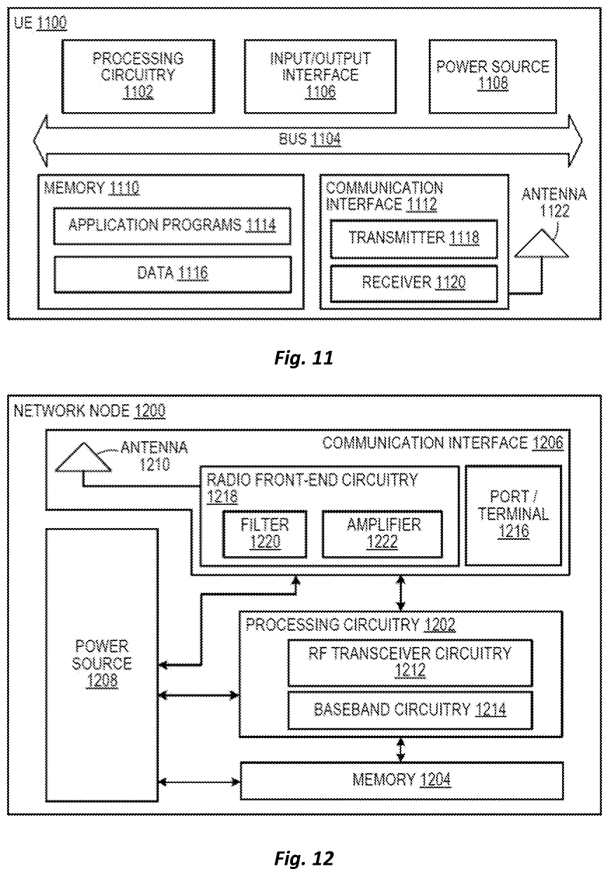

FIG. 11 shows a UE 1100 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1100 includes processing circuitry 1102 that is operatively coupled via a bus 1104 to an input/output interface 1106, a power source 1108, a memory 1110, a communication interface 1112, and/or any other component, or any combination thereof. Certain UEs may utilize all or a subset of the components shown in FIG. 11. The level of integration between the components may vary from one UE to another UE. Further, certain UEs may contain multiple instances of a component, such as multiple processors, memories, transceivers, transmitters, receivers, etc.

The processing circuitry 1102 is configured to process instructions and data and may be configured to implement any sequential state machine operative to execute instructions stored as machine-readable computer programs in the memory 1110. The processing circuitry 1102 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1102 may include multiple central processing units (CPUs).

In the example, the input/output interface 1106 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1100. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1108 is structured as a battery or battery pack. Other types of power sources, such as an external power source (e.g., an electricity outlet), photovoltaic device, or power cell, may be used. The power source 1108 may further include power circuitry for delivering power from the power source 1108 itself, and/or an external power source, to the various parts of the UE 1100 via input circuitry or an interface such as an electrical power cable. Delivering power may be, for example, for charging of the power source 1108. Power circuitry may perform any formatting, converting, or other modification to the power from the power source 1108 to make the power suitable for the respective components of the UE 1100 to which power is supplied.

The memory 1110 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1110 includes one or more application programs 1114, such as an operating system, web browser application, a widget, gadget engine, or other application, and corresponding data 1116. The memory 1110 may store, for use by the UE 1100, any of a variety of various operating systems or combinations of operating systems.

The memory 1110 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1110 may allow the UE 1100 to access instructions, application programs and the like, stored on transitory or non-transitory memory media, to off-load data, or to upload data. An article of manufacture, such as one utilizing a communication system may be tangibly embodied as or in the memory 1110, which may be or comprise a device-readable storage medium.

The processing circuitry 1102 may be configured to communicate with an access network or other network using the communication interface 1112. The communication interface 1112 may comprise one or more communication subsystems and may include or be communicatively coupled to an antenna 1122. The communication interface 1112 may include one or more transceivers used to communicate, such as by communicating with one or more remote transceivers of another device capable of wireless communication (e.g., another UE or a network node in an access network). Each transceiver may include a transmitter 1118 and/or a receiver 1120 appropriate to provide network communications (e.g., optical, electrical, frequency allocations, and so forth). Moreover, the transmitter 1118 and receiver 1120 may be coupled to one or more antennas (e.g., antenna 1122) and may share circuit components, software or firmware, or alternatively be implemented separately.

In the illustrated embodiment, communication functions of the communication interface 1112 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1112, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1100 shown in FIG. 11.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 12 shows a network node 1200 in accordance with some embodiments. The RAN node of the present disclosure may be implemented with the network node 1200. The network node may refer to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1200 includes a processing circuitry 1202, a memory 1204, a communication interface 1206, and a power source 1208. The network node 1200 may be composed of multiple physically separate components (e.g., a NodeB component and a RNC component, or a BTS component and a BSC component, etc.), which may each have their own respective components. In certain scenarios in which the network node 1200 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1200 may be configured to support multiple radio access technologies (RATs). In such embodiments, some components may be duplicated (e.g., separate memory 1204 for different RATs) and some components may be reused (e.g., a same antenna 1210 may be shared by different RATs). The network node 1200 may also include multiple sets of the various illustrated components for different wireless technologies integrated into network node 1200, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1200.

The processing circuitry 1202 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1200 components, such as the memory 1204, to provide network node 1200 functionality.

In some embodiments, the processing circuitry 1202 includes a system on a chip (SOC). In some embodiments, the processing circuitry 1202 includes one or more of radio frequency (RF) transceiver circuitry 1212 and baseband processing circuitry 1214. In some embodiments, the radio frequency (RF) transceiver circuitry 1212 and the baseband processing circuitry 1214 may be on separate chips (or sets of chips), boards, or units, such as radio units and digital units. In alternative embodiments, part or all of RF transceiver circuitry 1212 and baseband processing circuitry 1214 may be on the same chip or set of chips, boards, or units.

The memory 1204 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1202. The memory 1204 may store any suitable instructions, data, or information, including a computer program, software, an application including one or more of logic, rules, code, tables, and/or other instructions capable of being executed by the processing circuitry 1202 and utilized by the network node 1200. The memory 1204 may be used to store any calculations made by the processing circuitry 1202 and/or any data received via the communication interface 1206. In some embodiments, the processing circuitry 1202 and memory 1204 is integrated.

The communication interface 1206 is used in wired or wireless communication of signaling and/or data between a network node, access network, and/or UE. As illustrated, the communication interface 1206 comprises port(s)/terminal(s) 1216 to send and receive data, for example to and from a network over a wired connection. The communication interface 1206 also includes radio front-end circuitry 1218 that may be coupled to, or in certain embodiments a part of, the antenna 1210. Radio front-end circuitry 1218 comprises filters 1220 and amplifiers 1222. The radio front-end circuitry 1218 may be connected to an antenna 1210 and processing circuitry 1202. The radio front-end circuitry may be configured to condition signals communicated between antenna 1210 and processing circuitry 1202. The radio front-end circuitry 1218 may receive digital data that is to be sent out to other network nodes or UEs via a wireless connection. The radio front-end circuitry 1218 may convert the digital data into a radio signal having the appropriate channel and bandwidth parameters using a combination of filters 1220 and/or amplifiers 1222. The radio signal may then be transmitted via the antenna 1210. Similarly, when receiving data, the antenna 1210 may collect radio signals which are then converted into digital data by the radio front-end circuitry 1218. The digital data may be passed to the processing circuitry 1202. In other embodiments, the communication interface may comprise different components and/or different combinations of components.

In certain alternative embodiments, the network node 1200 does not include separate radio front-end circuitry 1218, instead, the processing circuitry 1202 includes radio front-end circuitry and is connected to the antenna 1210. Similarly, in some embodiments, all or some of the RF transceiver circuitry 1212 is part of the communication interface 1206. In still other embodiments, the communication interface 1206 includes one or more ports or terminals 1216, the radio front-end circuitry 1218, and the RF transceiver circuitry 1212, as part of a radio unit (not shown), and the communication interface 1206 communicates with the baseband processing circuitry 1214, which is part of a digital unit (not shown).

The antenna 1210 may include one or more antennas, or antenna arrays, configured to send and/or receive wireless signals. The antenna 1210 may be coupled to the radio front-end circuitry 1218 and may be any type of antenna capable of transmitting and receiving data and/or signals wirelessly. In certain embodiments, the antenna 1210 is separate from the network node 1200 and connectable to the network node 1200 through an interface or port.

The antenna 1210, communication interface 1206, and/or the processing circuitry 1202 may be configured to perform any receiving operations and/or certain obtaining operations described herein as being performed by the network node. Any information, data and/or signals may be received from a UE, another network node and/or any other network equipment. Similarly, the antenna 1210, the communication interface 1206, and/or the processing circuitry 1202 may be configured to perform any transmitting operations described herein as being performed by the network node. Any information, data and/or signals may be transmitted to a UE, another network node and/or any other network equipment.

The power source 1208 provides power to the various components of network node 1200 in a form suitable for the respective components (e.g., at a voltage and current level needed for each respective component). The power source 1208 may further comprise, or be coupled to, power management circuitry to supply the components of the network node 1200 with power for performing the functionality described herein. For example, the network node 1200 may be connectable to an external power source (e.g., the power grid, an electricity outlet) via an input circuitry or interface such as an electrical cable, whereby the external power source supplies power to power circuitry of the power source 1208. As a further example, the power source 1208 may comprise a source of power in the form of a battery or battery pack which is connected to, or integrated in, power circuitry. The battery may provide backup power should the external power source fail.

Embodiments of the network node 1200 may include additional components beyond those shown in FIG. 12 for providing certain aspects of the network node's functionality, including any of the functionality described herein and/or any functionality necessary to support the subject matter described herein. For example, the network node 1200 may include user interface equipment to allow input of information into the network node 1200 and to allow output of information from the network node 1200. This may allow a user to perform diagnostic, maintenance, repair, and other administrative functions for the network node 1200.

In various embodiments, network node 1200 can be configured to perform operations performed by network nodes, network functions (NFs), and application functions (AFs) in exemplary methods or procedures described above.

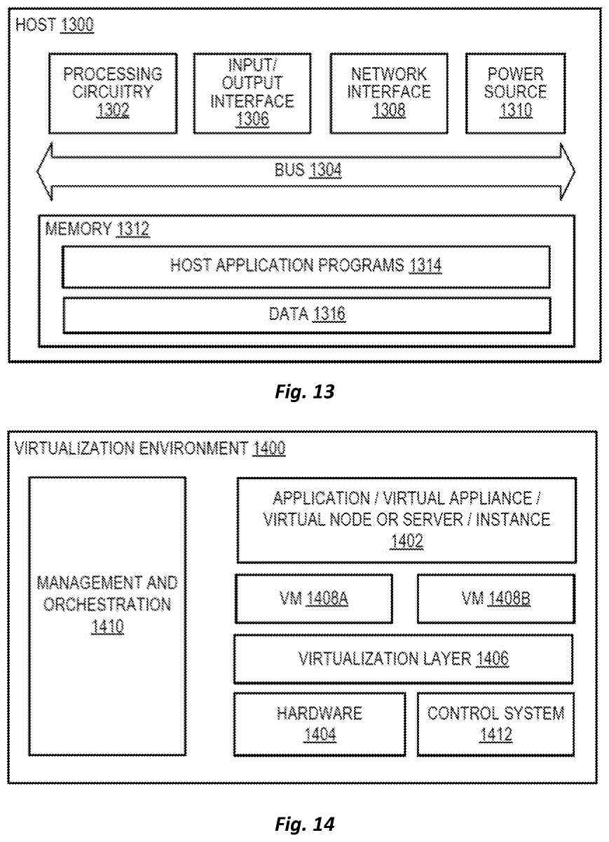

FIG. 13 is a block diagram of a host 1300, which may be an embodiment of the host 1016 of FIG. 10, in accordance with various aspects described herein. As used herein, the host 1300 may be or comprise various combinations hardware and/or software, including a standalone server, a blade server, a cloud-implemented server, a distributed server, a virtual machine, container, or processing resources in a server farm. The host 1300 may provide one or more services to one or more UEs.

The host 1300 includes processing circuitry 1302 that is operatively coupled via a bus 1304 to an input/output interface 1306, a network interface 1308, a power source 1310, and a memory 1312. Other components may be included in other embodiments. Features of these components may be substantially similar to those described with respect to the devices of previous figures, such as FIGS. 11 and 12, such that the descriptions thereof are generally applicable to the corresponding components of host 1300.

The memory 1312 may include one or more computer programs including one or more host application programs 1314 and data 1316, which may include user data, e.g., data generated by a UE for the host 1300 or data generated by the host 1300 for a UE. Embodiments of the host 1300 may utilize only a subset or all of the components shown. The host application programs 1314 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1314 may also provide for user authentication and licensing checks and may periodically report health, routes, and content availability to a central node, such as a device in or on the edge of a core network. Accordingly, the host 1300 may select and/or indicate a different host for over-the-top services for a UE. The host application programs 1314 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 14 is a block diagram illustrating a virtualization environment 1400 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1400 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1402 (which may alternatively be called software instances, virtual appliances, network functions, virtual nodes, virtual network functions, etc.) are run in the virtualization environment 1400 to implement some of the features, functions, and/or benefits of some of the embodiments disclosed herein.

Hardware 1404 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1406 (also referred to as hypervisors or virtual machine monitors (VMMs)), provide VMs 1408a and 1408b (one or more of which may be generally referred to as VMs 1408), and/or perform any of the functions, features and/or benefits described in relation with some embodiments described herein. The virtualization layer 1406 may present a virtual operating platform that appears like networking hardware to the VMs 1408.

The VMs 1408 comprise virtual processing, virtual memory, virtual networking or interface and virtual storage, and may be run by a corresponding virtualization layer 1406. Different embodiments of the instance of a virtual appliance 1402 may be implemented on one or more of VMs 1408, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1408 may be a software implementation of a physical machine that runs programs as if they were executing on a physical, non-virtualized machine. Each of the VMs 1408, and that part of hardware 1404 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1408 on top of the hardware 1404 and corresponds to the application 1402.

Hardware 1404 may be implemented in a standalone network node with generic or specific components. Hardware 1404 may implement some functions via virtualization. Alternatively, hardware 1404 may be part of a larger cluster of hardware (e.g., such as in a data center or CPE) where many hardware nodes work together and are managed via management and orchestration 1410, which, among others, oversees lifecycle management of applications 1402. In some embodiments, hardware 1404 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1412 which may alternatively be used for communication between hardware nodes and radio units.

In various embodiments, virtualization environment 1400 can be configured to host various network functions (NFs) and application functions (AFs) described above. In other words, these NFs and AFs can be implemented in respective virtual nodes 1402 based on underlying hardware 1404. These respective virtual nodes 1402 can be configured to perform various exemplary methods or procedures described above.

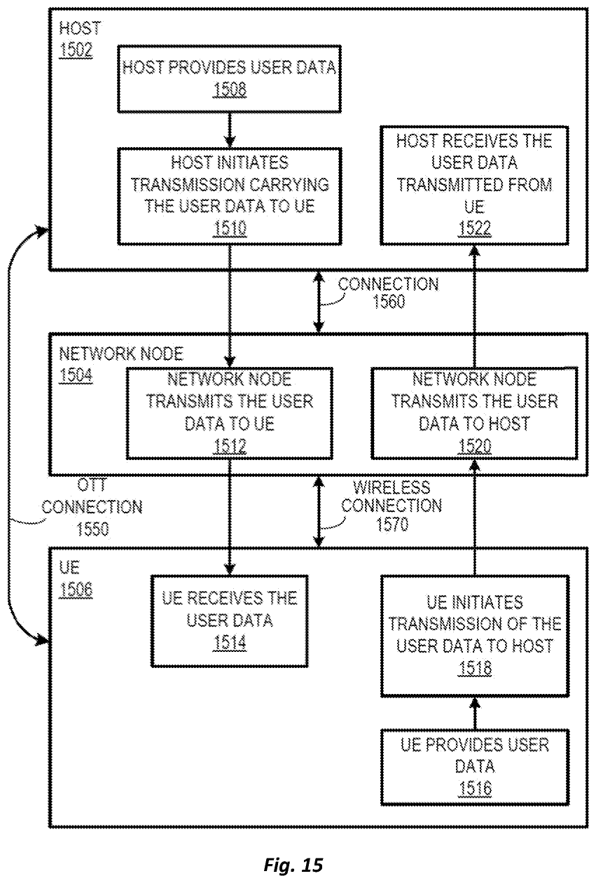

FIG. 15 shows a communication diagram of a host 1502 communicating via a network node 1504 with a UE 1506 over a partially wireless connection in accordance with some embodiments. Example implementations, in accordance with various embodiments, of the UE (such as a UE 1012a of FIG. 10 and/or UE 1100 of FIG. 11), network node (such as network node 1010a of FIG. 10 and/or network node 1200 of FIG. 12), and host (such as host 1016 of FIG. 10 and/or host 1300 of FIG. 13) discussed in the preceding paragraphs will now be described with reference to FIG. 15.

Like host 1300, embodiments of host 1502 include hardware, such as a communication interface, processing circuitry, and memory. The host 1502 also includes software, which is stored in or accessible by the host 1502 and executable by the processing circuitry. The software includes a host application that may be operable to provide a service to a remote user, such as the UE 1506 connecting via an over-the-top (OTT) connection 1550 extending between the UE 1506 and host 1502. In providing the service to the remote user, a host application may provide user data which is transmitted using the OTT connection 1550.

The network node 1504 includes hardware enabling it to communicate with the host 1502 and UE 1506. The connection 1560 may be direct or pass through a core network (like core network 1006 of FIG. 10) and/or one or more other intermediate networks, such as one or more public, private, or hosted networks. For example, an intermediate network may be a backbone network or the Internet.

The UE 1506 includes hardware and software, which is stored in or accessible by UE 1506 and executable by the UE's processing circuitry. The software includes a client application, such as a web browser or operator-specific “app” that may be operable to provide a service to a human or non-human user via UE 1506 with the support of the host 1502. In the host 1502, an executing host application may communicate with the executing client application via the OTT connection 1550 terminating at the UE 1506 and host 1502. In providing the service to the user, the UE's client application may receive request data from the host's host application and provide user data in response to the request data. The OTT connection 1550 may transfer both the request data and the user data. The UE's client application may interact with the user to generate the user data that it provides to the host application through the OTT connection 1550.

The OTT connection 1550 may extend via a connection 1560 between the host 1502 and the network node 1504 and via a wireless connection 1570 between the network node 1504 and the UE 1506 to provide the connection between the host 1502 and the UE 1506. The connection 1560 and wireless connection 1570, over which the OTT connection 1550 may be provided, have been drawn abstractly to illustrate the communication between the host 1502 and the UE 1506 via the network node 1504, without explicit reference to any intermediary devices and the precise routing of messages via these devices.

As an example of transmitting data via the OTT connection 1550, in step 1508, the host 1502 provides user data, which may be performed by executing a host application. In some embodiments, the user data is associated with a particular human user interacting with the UE 1506. In other embodiments, the user data is associated with a UE 1506 that shares data with the host 1502 without explicit human interaction. In step 1510, the host 1502 initiates a transmission carrying the user data towards the UE 1506. The host 1502 may initiate the transmission responsive to a request transmitted by the UE 1506. The request may be caused by human interaction with the UE 1506 or by operation of the client application executing on the UE 1506. The transmission may pass via the network node 1504, in accordance with the teachings of the embodiments described throughout this disclosure. Accordingly, in step 1512, the network node 1504 transmits to the UE 1506 the user data that was carried in the transmission that the host 1502 initiated, in accordance with the teachings of the embodiments described throughout this disclosure. In step 1514, the UE 1506 receives the user data carried in the transmission, which may be performed by a client application executed on the UE 1506 associated with the host application executed by the host 1502.

In some examples, the UE 1506 executes a client application which provides user data to the host 1502. The user data may be provided in reaction or response to the data received from the host 1502. Accordingly, in step 1516, the UE 1506 may provide user data, which may be performed by executing the client application. In providing the user data, the client application may further consider user input received from the user via an input/output interface of the UE 1506. Regardless of the specific manner in which the user data was provided, the UE 1506 initiates, in step 1518, transmission of the user data towards the host 1502 via the network node 1504. In step 1520, in accordance with the teachings of the embodiments described throughout this disclosure, the network node 1504 receives user data from the UE 1506 and initiates transmission of the received user data towards the host 1502. In step 1522, the host 1502 receives the user data carried in the transmission initiated by the UE 1506.

One or more of the various embodiments improve the performance of OTT services provided to the UE 1506 using the OTT connection 1550, in which the wireless connection 1570 forms the last segment. More precisely, embodiments described herein can provide a new service operation by which an NEF can request a UDM to remove authorization related to a service-specific parameter provisioning request, e.g., before a validity time for the authorization expires. Upon receiving such a request, the UDM can release and stop monitoring for updates pertaining to the resources related to the authorization This avoids waste of UDM resources (e.g., signaling, processing, storage, etc.) and facilitates more efficient operation of the 5GC. These increased efficiencies improve the delivery of OTT services via the 5GC, thereby increasing the value of such OTT services to both end users and service providers.

In an example scenario, factory status information may be collected and analyzed by the host 1502. As another example, the host 1502 may process audio and video data which may have been retrieved from a UE for use in creating maps. As another example, the host 1502 may collect and analyze real-time data to assist in controlling vehicle congestion (e.g., controlling traffic lights). As another example, the host 1502 may store surveillance video uploaded by a UE. As another example, the host 1502 may store or control access to media content such as video, audio, VR or AR which it can broadcast, multicast or unicast to UEs. As other examples, the host 1502 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1550 between the host 1502 and UE 1506, in response to variations in the measurement results. The measurement procedure and/or the network functionality for reconfiguring the OTT connection may be implemented in software and hardware of the host 1502 and/or UE 1506. In some embodiments, sensors (not shown) may be deployed in or in association with other devices through which the OTT connection 1550 passes; the sensors may participate in the measurement procedure by supplying values of the monitored quantities exemplified above, or supplying values of other physical quantities from which software may compute or estimate the monitored quantities. The reconfiguring of the OTT connection 1550 may include message format, retransmission settings, preferred routing etc.; the reconfiguring need not directly alter the operation of the network node 1504. Such procedures and functionalities may be known and practiced in the art. In certain embodiments, measurements may involve proprietary UE signaling that facilitates measurements of throughput, propagation times, latency and the like, by the host 1502. The measurements may be implemented in that software causes messages to be transmitted, in particular empty or ‘dummy’ messages, using the OTT connection 1550 while monitoring propagation times, errors, etc.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures that, although not explicitly shown or described herein, embody the principles of the disclosure and can be thus within the spirit and scope of the disclosure. Various embodiments can be used together with one another, as well as interchangeably therewith, as should be understood by those having ordinary skill in the art.

The term unit, as used herein, can have conventional meaning in the field of electronics, electrical devices and/or electronic devices and can include, for example, electrical and/or electronic circuitry, devices, modules, processors, memories, logic solid state and/or discrete devices, computer programs or instructions for carrying out respective tasks, procedures, computations, outputs, and/or displaying functions, etc., such as those that are described herein.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

As described herein, device and/or apparatus can be represented by a semiconductor chip, a chipset, or a (hardware) module comprising such chip or chipset; this, however, does not exclude the possibility that a functionality of a device or apparatus, instead of being hardware implemented, be implemented as a software module such as a computer program or a computer program product comprising executable software code portions for execution or being run on a processor. Furthermore, functionality of a device or apparatus can be implemented by any combination of hardware and software. A device or apparatus can also be regarded as an assembly of multiple devices and/or apparatuses, whether functionally in cooperation with or independently of each other. Moreover, devices and apparatuses can be implemented in a distributed fashion throughout a system, so long as the functionality of the device or apparatus is preserved. Such and similar principles are considered as known to a skilled person.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

In addition, certain terms used in the present disclosure, including the specification and drawings, can be used synonymously in certain instances (e.g., “data” and “information”). It should be understood, that although these terms (and/or other terms that can be synonymous to one another) can be used synonymously herein, there can be instances when such words can be intended to not be used synonymously. Further, to the extent that the prior art knowledge has not been explicitly incorporated by reference herein above, it is explicitly incorporated herein in its entirety. All publications referenced are incorporated herein by reference in their entireties.

1-36. (canceled)

37. A method in a Radio Access Network (RAN) node, the method comprising:
triggering a Session Management Function (SMF) pause of charging after a paging failure for a user equipment (UE) in Radio Resource Control (RRC) inactive status.

38. The method of claim 37, further comprising:
being informed, by the SMF, of a first threshold of dropped packets.

39. The method of claim 38, wherein the RAN node is informed of the first threshold by receiving a first message including the first threshold from the SMF.

40. The method of claim 39, wherein the first message comprises:
Protocol Data Unit (PDU) Session Resource Setup Request message during PDU Session Establishment procedure or Evolved Packet System (EPS) to 5G System (5GS) mobility procedure or N2 based Inter NG-RAN node handover, wherein the first threshold is included in PDU Session Resource Setup Request Transfer IE, or
Path Switch Request Acknowledge message during Xn based Inter NG-RAN handover, wherein the first threshold is included in Path Switch Request Acknowledge Transfer IE.

41. The method of claim 38, wherein, conditioned on the N2 connection being kept, the RAN node triggers the SMF pause of charging by:
when a number of downlink packets dropped at the RAN node after the paging failure reaches the first threshold, informing the SMF of a first indicator indicating that the number of downlink packets dropped at the RAN node reaches the first threshold.

42. The method of claim 41, wherein the RAN node includes or enables the first indicator in a second message, and sending the second message to the SMF; and
when the paging for the UE is successful, informing the SMF to stop the pause of charging.

43. The method of claim 42, wherein the RAN node informs the SMF to stop the pause of charging by:
including or enabling a second indicator in a third message, and sending the third message to the SMF, wherein the second indicator indicates that RRC connection for the UE is resumed.

44. The method of claim 43, wherein each of the second and third messages comprises PDU Session Resource Notify message, wherein each of the first and second indicators is included in PDU Session Resource Notify Transfer IE.

45. The method of claim 38, wherein the RAN node triggers the SMF pause of charging by:
initiating AN release procedure when a number of downlink packets dropped at the RAN node after the page failure reaches the first threshold, and
informing a number of downlink packets dropped at the RAN node before the AN release procedure to Access and Mobility Management Function (AMF) via which the number of downlink packets is to be forwarded to the SMF.

46. The method of claim 37, wherein if the RAN node initiates AN release procedure after the paging failure, the RAN node triggers the SMF pause of charging by:
informing a number of downlink packets dropped at the RAN node before the AN release procedure to Access and Mobility Management Function (AMF) via which the number of downlink packets is to be forwarded to the SMF.

47. The method of claim 45, wherein the RAN node includes the number of downlink packets dropped at the RAN node in a UE Context Release Request message sent to the AMF.

48. A method in a Session Management Function (SMF), the method comprising:
being triggered for pause of charging by a Radio Access Network (RAN) node after a paging failure for a user equipment (UE) in Radio Resource Control (RRC) inactive status; and
enabling pause of charging.

49. The method of claim 48, further comprising:
informing the RAN node of a first threshold of dropped packets.

50. The method of claim 49, wherein the SMF informs the RAN node of the first threshold by including it in a first message sent to the RAN node; and
the first message comprises:
PDU Session Resource Setup Request message during PDU Session Establishment procedure or EPS to 5GS mobility procedure or N2 based Inter NG-RAN node handover, wherein the first threshold is included in PDU Session Resource Setup Request Transfer IE,
Path Switch Request Acknowledge message during Xn based Inter NG-RAN handover, wherein the first threshold is included in Path Switch Request Acknowledge Transfer IE.

51. The method of claim 49, wherein the SMF is triggered for pause of charging by:
receiving, from the RAN node that keeps N2 connection after the paging failure, a first indicator indicating that a number of downlink packets dropped at the RAN node after the paging failure reaches the first threshold;
wherein the SMF enables the pause of charging by:
in response to receiving the first indicator, sending a request for stopping charging counting to User Plane Function (UPF);
and wherein the first indicator is included or enabled in a second message received by the SMF.

52. The method of claim 51, further comprising:
being informed by the RAN node to stop the pause of charging; and
stopping the pause of charging;
wherein the SMF is informed to stop the pause of charging by:
receiving, from the RAN node, a second indicator included or enabled in a third message, wherein the second indicator indicates that RRC connection for the UE is resumed;
wherein the SMF stops the pause of charging by:
in response to receiving the second indicator, sending a request for starting charging counting to the UPF.

53. The method of claim 52, wherein each of the second and third messages comprises PDU Session Resource Notify message, wherein each of the first and second indicators is included in PDU Session Resource Notify Transfer IE.

54. A method in Access and Mobility Management Function (AMF), the method comprising:
receiving, from a Radio Access Network (RAN) node, a number of downlink packets dropped at the RAN node after a paging failure for a User Equipment (UE) in Radio Resource Control (RRC) inactive status; and
sending the number of downlink packets dropped at the RAN node to Session Management Function (SMF).

55. A Radio Access Network (RAN) node comprising:
communication interface circuitry; and
processing circuitry that is operably coupled to the communication interface circuitry; the processing circuitry and communication interface circuitry being configured to perform operations corresponding to claim 37.
